(19) United States
(12) Patent Application Publication
(10) Pub. No.: US 2013/0342444 A1
(43) Pub. Date: Dec. 26, 2013

(54) Method and Apparatus for Hand Gesture Trajectory Recognition

(71) Applicant: FUJITSU LIMITED, Kawasaki (JP)

(72) Inventor: Zhiming TAN, Shanghai (CN)

(21) Appl. No.: 13/923,030

(22) Filed: Jun. 20, 2013

(30) Foreign Application Priority Data
Jun. 21, 2012 (CN) 201210223645.2

(51) Int. Cl. G06F 3/01

(52) U.S. Cl. CPC G06F 3/017
USPC 345/156

(57) ABSTRACT

Method and apparatus for hand gesture trajectory recognition. The method includes: pre-defining sixteen hand gesture trajectory models, and classifying the sixteen hand gesture trajectory models into three types of hand gesture trajectory models; judging an input hand gesture trajectory belongs to which type of the three types of hand gesture trajectory models; and recognizing input hand gesture trajectories that belong to different types of hand gesture trajectory models with different methods.

### FIELD OF THE INVENTION

The invention relates to image processing, and in particular, to a method and apparatus for hand gesture trajectory recognition.

### BACKGROUND ART

Currently there are many methods of recognizing the meaning of hand gesture trajectories; most of which follow the following framework: firstly getting the hand gesture trajectory template with pre-defined features by training hand gestures; and then judging an actual hand gesture trajectory by comparing the features of the hand gesture trajectory template with the features extracted from input images. These methods need a long computational time to train hand gestures and to further obtain a hand gesture trajectory template; extracting features from input images in real time and comparing them with the features of the hand gesture trajectory template would also take a lot of time.

Low power applications referring to hand gesture trajectory recognition comprise smart home devices, mobile devices, and other types of handheld devices. Hand gesture trajectory recognition process in low power applications need to use the simplest possible algorithms and features to realize hand gesture trajectory recognition under the condition that an acceptable precision is ensured. Thus the template without training, and simple feature extracting and comparing would be more applicable.

### SUMMARY OF THE INVENTION

As to the problems stated above, the invention provides a novel method and apparatus for hand gesture trajectory recognition.

A method for hand gesture trajectory recognition based on embodiments of the invention comprises: pre-defining sixteen hand gesture trajectory models, and classifying the sixteen hand gesture trajectory models into three types of hand gesture trajectory models in accordance with the number of key points included in respective hand gesture trajectory models of the sixteen hand gesture trajectory models; judging an input hand gesture trajectory belongs to which type of the three types of hand gesture trajectory models in accordance with the number of key points included in the input hand gesture trajectory; and recognizing input hand gesture trajectories that belong to different types of hand gesture trajectory models with different methods, wherein, as to any one of the sixteen hand gesture trajectory models or the input gesture trajectory, its start point and end point are both key points, and for any one current point on the one hand gesture trajectory model or the input hand gesture trajectory, if the current point is located within a same quadrant as a previous key point, the current point is judged as a regular point, or else the current point is judged as a key point.

An apparatus for hand gesture trajectory recognition based on embodiments of the invention comprises: a model defining unit for pre-defining sixteen hand gesture trajectory models, and classifying the sixteen hand gesture trajectory models into three types of hand gesture trajectory models in accordance with the number of key points included in respective hand gesture trajectory models of the sixteen hand gesture trajectory models; a type judging unit for judging an input hand gesture trajectory belongs to which type of the three types of hand gesture trajectory models in accordance with the number of key points included in the input hand gesture trajectory; and a trajectory recognizing unit for recognizing input hand gesture trajectories that belong to different types of hand gesture trajectory models with different methods, wherein, as to any one of the sixteen hand gesture trajectory models or the input gesture trajectory, its start point and end point are both key points, and for any one current point on the one hand gesture trajectory model or the input hand gesture trajectory, if the current point is located within a same quadrant as a previous key point, the current point is judged as a regular point, or else the current point is judged as a key point.

In the method and apparatus for hand gesture trajectory recognition based on embodiments of the invention, sixteen hand gesture trajectory models may be defined easily and may be classified into three types without the need of training model, so that it lightens the computational load, and is suitable for low power applications.

### DESCRIPTION OF THE DRAWINGS

The invention may be better understood through the following description referring to the accompanying drawings; wherein:

FIG. 1 shows a block diagram of an apparatus for hand gesture trajectory recognition based on embodiments of the invention;

FIG. 2 shows a flow diagram of a method for hand gesture trajectory recognition based on embodiments of the invention;

FIG. 3 shows each one-eighth quadrant of the rectangular coordinate used in the method and apparatus for hand gesture trajectory recognition based on embodiments of this invention; and numerals representing each of the one-eighth quadrants;

FIG. 4 shows an example of characteristics of number “2” obtained according to the numerals shown in FIG. 3; and

FIG. 5 shows sign curves of numbers 0 to 9 and chain codes of each sign curve.

### DETAILED EMBODIMENTS

Next features and exemplary embodiments of various aspects of the invention will be described in detail. The following description covers many specific details so as to provide comprehensive understanding of the invention. However, it would be obvious for those skilled in the art that the invention may be performed in absence of some of the specific details. The following descriptions of embodiments only aim at providing a clearer understanding of the invention through showing examples of the invention. The invention is not limited to any specific configurations and algorithms provided below; instead, it covers any modification, substitution, and improvement of corresponding elements, components and algorithms without departing from the spirit of the invention.

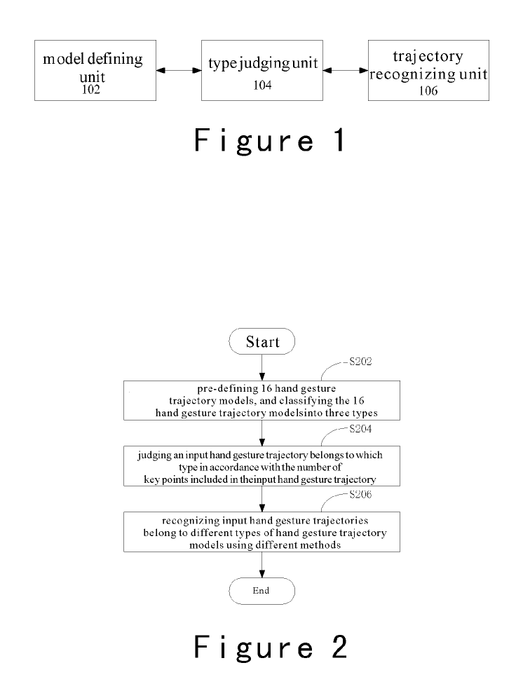

FIG. 1 shows a block diagram of an apparatus for hand gesture trajectory recognition based on embodiments of the invention; FIG. 2 shows a flow diagram of a method for hand gesture trajectory recognition based on embodiments of the invention. Next the method and apparatus for hand gesture trajectory recognition based on embodiments of this invention will be described in detail referring to FIGS. 1 and 2.

As shown in FIG. 1, an apparatus for hand gesture trajectory recognition based on embodiments of the invention comprises: a model defining unit 102, a type judging unit 104 and a trajectory recognizing unit 106. Wherein the model defining unit 102 is for pre-defining sixteen hand gesture trajectory models, and classifying the sixteen hand gesture trajectory models into three types of hand gesture trajectory models in accordance with the number of key points included in respective hand gesture trajectory models of the sixteen hand gesture trajectory models (i.e., performing step S202); the type judging unit 104 is for judging an input hand gesture trajectory belongs to which type of the three types of hand gesture trajectory models in accordance with the number of key points included in the input hand gesture trajectory (i.e., performing step S204); and the trajectory recognizing unit 206 is for recognizing input hand gesture trajectories that belong to different types of hand gesture trajectory models with different methods (i.e., performing step S206). Specifically, the model defining unit 102 uses chain code to pre-define sixteen hand gesture trajectory models. Then the trajectory recognizing unit 206 uses the chain code extracted from an actual gesture trajectory input and the chain code of the pre-defined gesture trajectory model to recognize the actual gesture trajectory input during the procedure of gesture trajectory recognition. Next detailed process of the method and apparatus for hand gesture trajectory recognition based on embodiments of this invention will be described.

In the invention, it is assumed that a start frame and an end frame forming a hand gesture trajectory are known, the rectangle of hand area in each frame is detected in a right way, and the central point of the rectangle in one frame (located between the start and end frames including the start and end frames themselves.) is regarded as a discrete point consisting a hand gesture trajectory.

S202: pre-defining sixteen hand gesture trajectory models, and classifying the sixteen hand gesture trajectory models.

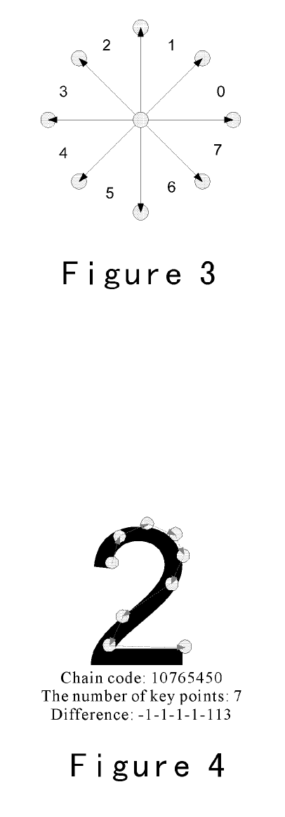

FIG. 3 shows each one-eighth quadrant of the rectangular coordinate used in the method and apparatus for hand gesture trajectory recognition according to embodiments of this invention; and numerals representing each of the one-eighth quadrants. Specifically, as shown in FIG. 3, the rectangular coordinate is divided into eight quadrants, and the eight quadrants are represented using counterclockwise-counted numerals of 0 to 7 respectively. Wherein 0 represents a first quadrant corresponding to [0°, 45°), 1 represents a second quadrant corresponding to [45°, 90°), 2 represents a third quadrant corresponding to [90°, 135°), 3 represents a fourth quadrant corresponding to [135°, 180°), 4 represents a fifth quadrant corresponding to [180°, 225°), 5 represents a sixth quadrant corresponding to [225°, 270°), 6 represents a seventh quadrant corresponding to [270°, 315°) and 7 represents a eighth quadrant corresponding to [310°, 360°).

Before defining a hand gesture trajectory recognition model, firstly each discrete point in a sign curve (i.e., a hand gesture trajectory) needed to be distinguished as a regular point or a key point. Specifically, in a plurality of discrete points consisting a sign curve, both a start point and an end point are regarded as key points, discrete points located within the same quadrant with the previous key point are regarded as regular points, and discrete points located in a different quadrant compared with the previous key point are regarded as regular points.

It should be noted that, for any discrete point P1 apart from the start and end points among a plurality of discrete points consisting a hand gesture trajectory (i.e., a sign curve), the quadrant in which the discrete point P1 is located refers to the one-eighth quadrant in which a vector pointing from a previous discrete point P0 toward P1 is located in a rectangular coordinate whose original point is the discrete point P0. In embodiments of the invention, chain code that is consisted of numerals representing one-eighth quadrants in which key points of a sign curve is located may be used to represent the sign curve (here, the chain code may be used as a characteristic of the sign curve).

In addition, if the direction between adjacent key points in a certain sign curve changes in counterclockwise (i.e., the one-eighth quadrants in which the adjacent key points in the sign curve changes in counterclockwise, for example, chain code of the sign curve is 01234), then difference between the numbers in the chain code of the sign curve will be positive (for example, 2-1, 3-2, 4-3 etc.). Otherwise if the direction between adjacent key points in a certain sign curve changes in clockwise (i.e., the one-eighth quadrants in which the adjacent key points in the sign curve changes in clockwise, for example, chain code of the sign curve is 07654), then difference between the numbers in the chain code of the sign curve will be negative (for example, 7-0, 6-7, 5-6 etc.).

Chain code of a sign curve, differential mode in the chain code and the number of key points in the chain code may be used to define a sign curve. FIG. 4 shows a sign curve of an example number “2” and directions of key points in the sign curve.

As shown in FIG. 4, sign curve of the number “2” comprises seven key points, and chain code of the sign curve is 1076540 (wherein each number is the numbers that represent the one-eighth quadrants in which the key points of the sign curve are located), and differential mode in the chain code of the sign curve is -1-1-1-1-113 (i.e., a serial of numbers consisted of the difference between a next number and a previous number in the chain code).

The aforementioned rule for determining key points is applicable for both hand gesture trajectory model and input hand gesture trajectory. In embodiments of the invention, chain code is defined as the basic feature of a hand gesture trajectory model. Since an actual hand gesture trajectory may not perfectly follow the sign curve of the defined hand gesture trajectory, thus apart from the chain code, the number of key points in the chain code and differential mode in the chain code may be used to limit hand gesture trajectory model. Wherein the number of key points in a chain code shows quadrant changing frequency of the key points in the chain code, and length of the curve. Differential mode in the chain code shows changing trend of the hand gesture trajectory (i.e., the sign curve) (that is, it shows changing trend of one-eighth quadrants in which each key point in the hand gesture trajectory is located).

Specifically, a differential mode in the chain is obtained by subtracting the latter number with the current number. For example, regarding the chain code of 10765450, the difference (0-1)(7-0)(6-7)(5-6)(4-5)(5-4)(0-5) may be obtained, i.e., -1-1-1-1-113. It should be noted that the difference is calculated in the shortest way of one-eighth quadrant changing, and the absolute difference should be equal to or less than 4. Therefore, if the quadrant changing is counterclockwise, the difference will be positive; otherwise, it will be negative. For example, if the current number is 0, and the later number is 7, then the direction of the sign curve changes clockwise and the difference is −1. Although 7−0=7, it should be −1, because the 0 here may be regarded as 8. Regarding, for example, the two numbers 50 in 10765450, the same story is for the two numbers. Since the direction of the sign curve changes in counterclockwise, the difference between 0 and 5 will be 3. Although 0−5=−5, it should be 3, because the 0 here may be regarded as 8.

In embodiments of the invention, 16 types of hand gesture trajectories (left, right, up, down, clockwise, counterclockwise, wave, zero, one, two, three, four, five, six, seven, eight, and nine) are defined in following table. These 16 types of hand gesture trajectories would be enough for command interfaces of low power applications.

TABLE 1

| Hand | | | Key | |
|---|---|---|---|---|
| gesture | | | point | |
| trajecto- | | | | Difference in |
| ries | meaning | Chain code | number | chain code |
| [symbol] | left | 3 or 4 | 1 | — |
| [symbol] | right | 0 or 7 | 1 | — |
| \| | up | 1 or 2 | 1 | — |
| [symbol] | down | 5 or 6 | 1 | |
| [symbol] | clockwise | 76543210 | 8 | -1-1-1-1-1-1-1 |
| [symbol] | counter- | 45670123 | 8 | 1111111 |
| | clockwise | | | |
| [symbol] | wave | 7373 or 7474 or | 4 | — |
| | | 0404 or 0303, | | |
| | | repeated | | |
| 0 | zero | 76543210 | 8 | -1-1-1-1-1-1-1 |
| 1 | one | 016 or 015 or | 3 or 2 | — |
| | | 16 or 15 or | | |
| | | 06 or 05 | | |
| 2 | two | 10765450 | 8 | -1-1-1-1-113 |
| 3 | three | 107654765432 | 12 | -1-1-1-13-1-1-1-1-1 |
| 4 | four | 316 or 416 or | 3 | — |
| | | 306 or 406 or | | |
| | | 315 or 415 or | | |
| | | 305 or 405 | | |
| 5 | five | 5410765432 | 10 | 1-4-1-1-1-1-1-1-1 |
| 6 | six | 234567012345 | 12 | 1111111111 |
| 7 | seven | 045 or 145 or | 3 or 2 | — |
| | | 04 or 14 or | | |
| | | 05 or 15 | | |
| 8 | eight | 76545670123210 | 14 | -1-1-11111111-1-1-1 |
| 9 | nine | 543210765432 | 12 | -1-1-1-1-1-1-1-1-1-1-1 |

In Table 1, according to different numbers of the key points, hand gesture trajectories may be classified into 3 types. The first type of hand gesture trajectory is for the key point number equal to or less than 4, including left, right, up, down, wave, 1, 4, and 7. The second type of hand gesture trajectory is for the key point number from 8 to 10, including clockwise, counterclockwise, 0, 2, and 5. And the third type of hand gesture trajectory is for the key point number larger than 12, including 3, 6, 8, and 9.

Regarding the first type of hand gesture trajectory, the first chain code in the column in Table 1 is a standard chain code of the hand gesture trajectory model. Since actual hand gesture trajectory may not perfectly follow the sign curve of the defined hand gesture trajectory, some other chain codes are defined. For example, the standard trajectory of moving right is moving from left to right horizontally, i.e., “ [symbol] ”; thus the standard chain code is 0. An actual hand gesture of moving right may be moving from left down to right up, or moving from left up to right down; so the chain code is not only 0, but it may also be 7. The difference in chain code does not need to be calculated for the first type of hand gesture trajectory; and for the second type and third type, only their standard chain code is shown in Table 1.

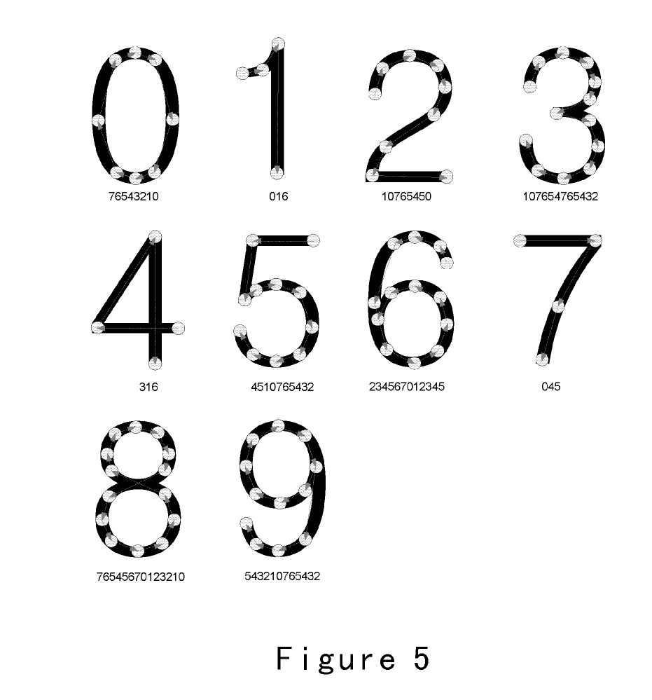

FIG. 5 shows standard chain codes of sign curves of 0 to 9. Apart from the standard chain code, there are some other chain codes for the sign 2 and 5 (which would affect the pattern of the difference in the chain code). For example, for the sign 2, the difference may be -1-1-1-1-112; and for the sign 5, the difference can be 2-4-1-1-1-1-1-1-1.

S204, judging an input hand gesture trajectory belongs to which type of the three types of hand gesture trajectory models

Firstly, extract key points in an input hand gesture trajectory. Here the start point and end point of the input hand gesture trajectory are both regarded as key points. And here the start point of the input hand gesture trajectory is the first key point of the input hand gesture trajectory, and quadrant of the first key point is defined as the one-eighth quadrant in which a vector pointing from the start point of the input hand gesture toward a first discrete point following the start point is located in a rectangular coordinate whose original point is the first discrete point.

Then for any discrete point P1 apart from the start, the end point and the first point, the quadrant in which the discrete point P1 is located refers to the one-eighth quadrant in which a vector pointing from a previous discrete point P0 toward P1 is located in a rectangular coordinate whose original point is the discrete point P0. If the quadrant in which the discrete point P1 is located is a same one-eighth quadrant as the quadrant in which the nearest previous key point is located, the discrete point P1 is judged as a regular point, or else the discrete point P1 is judged as a key point.

After traversed all discrete points in the input hand gesture trajectory by the aforementioned process, the number of key points included in the input hand gesture trajectory may be determined, then the input hand gesture trajectory may be judged as belong to which type of the three types of hand gesture trajectory models in accordance with the number of key points included in the input hand gesture trajectory.

S206, recognizing input hand gesture trajectories belong to different types of hand gesture trajectory models using different methods

Regarding input hand gesture trajectories belong to the first type of hand gesture trajectory model, it only needs to compare differential mode in the chain code of the input hand gesture trajectory with differential modes of each hand gesture trajectory models of the first type of hand gesture trajectory model to recognize which gesture trajectory model of the first type of hand gesture trajectory model the input hand gesture trajectory should be regarded as (i.e., recognizing meaning of the input hand gesture trajectory).

Regarding input hand gesture trajectories belong to the second or the third type of hand gesture trajectory model, it only needs to compare differential mode in the chain code of the input hand gesture trajectory with differential modes of each hand gesture trajectory models of the second or the third type of hand gesture trajectory model to recognize which gesture trajectory model of the second or the third type of hand gesture trajectory model the input hand gesture trajectory should be regarded as (i.e., recognizing meaning of the input hand gesture trajectory). In order to improve tolerance of actual hand gesture trajectory, the number of difference can be one more than or one less than the standard chain code difference. For example, the standard chain code difference for the sign 0 is -1-1-1-1-1-1-1. If the actual difference is -1-1-1-1-1-1 or -1-1-1-1-1-1-1-1, it will still be judged as 0.

As can be seen, the method and apparatus for hand gesture trajectory recognition according to embodiments of the invention may define sixteen hand gesture trajectory models easily and classify them into three types without the need of training model, so that it lightens computational load, and is suitable for low power applications.

Although the invention has been described with reference to detailed embodiments of the invention, those skilled in the art would understand that modifications, combinations and changes may be done to the detailed embodiments without departing from the scope and spirit of the invention as defined by the appended claims and the equivalents thereof.

Hardware or software may be used to perform the steps based on needs. It should be noted that under the premise of not departing from the scope of the invention, the steps may be amended, added to or removed from the flow diagram provided by the description. Generally, a flow diagram is only one possible sequence of basic operations performing functions.

Embodiments of the invention may be implemented using a general programmable digital computer, a specific integrated circuit, programmable logic devices, a field-programmable gate array, and optical, chemical, biological, quantum or nano-engineering systems, components and institutions. Generally, functions of the invention may be realized by any means known to those skilled in the art. Distributed or networked systems, components and circuits may be used. And data may be transmitted wired, wirelessly, or by any other means.

It shall be realized that one or more elements illustrated in the accompanying drawings may be realized in a more separated or more integrated method; they would even be allowed to be removed or disabled under some conditions. Realizing programs or codes capable of being stored in machine readable media so as to enable a computer to perform the aforementioned method also fails within spirit and scope of the invention.

Additionally, any arrows in the accompanying drawings shall be regarded as being exemplary rather than limiting. And unless otherwise indicated in detail, combinations of components and steps shall be regarded as being recorded when terms are foreseen as leading unclearity to the ability for separating or combining.

What is claimed is:

1. A hand gesture trajectory recognition method, comprising:
pre-defining sixteen hand gesture trajectory models, and classifying the sixteen hand gesture trajectory models into three types of hand gesture trajectory models in accordance with the number of key points included in respective hand gesture trajectory models of the sixteen hand gesture trajectory models;
judging an input hand gesture trajectory belongs to which type of the three types of hand gesture trajectory models in accordance with the number of key points included in the input hand gesture trajectory; and
recognizing input hand gesture trajectories that belong to different types of hand gesture trajectory models with different methods,
wherein, as to any one of the sixteen hand gesture trajectory models or the input gesture trajectory, its start point and end point are both key points, and for any one current point on the one hand gesture trajectory model or the input hand gesture trajectory, if the current point is located within a same quadrant as a previous key point, the current point is judged as a regular point, or else the current point is judged as a key point.

2. The hand gesture trajectory recognition method of claim 1, characterized in taking hand gesture trajectory models, the number of key points included in which is less than or equal to “4”, as a first type of hand gesture trajectory models, taking hand gesture trajectory models, the number of key points included in which is larger than 4 and not larger than 10, as a second type of hand gesture trajectory models, and taking hand gesture trajectory models, the number of key points included in which is larger than 10, as a third type of hand gesture trajectory models.

3. The hand gesture trajectory recognition method of claim 2, characterized in when the input hand gesture trajectory belongs to the first type of hand gesture trajectory models, judging the input hand gesture trajectory shall be taken as which one hand gesture trajectory in the first type of hand gesture trajectory models by comparing a code chain of the input hand gesture trajectory and code chains of every hand gesture trajectory models in the first type of hand gesture trajectory models.

4. The hand gesture trajectory recognition method of claim 2, characterized in when the input hand gesture trajectory belongs to the second or third type of hand gesture trajectory models, judging the input hand gesture trajectory shall be taken as which one hand gesture trajectory model in the second or third hand gesture trajectory models by comparing a difference mode in a code chain of the input hand gesture trajectory and difference modes in code chains of the second or third types of hand gesture trajectory models.

5. The hand gesture trajectory recognition method of claim 1, characterized in representing the sixteen hand gesture trajectory models by using code chains respectively corresponding to the sixteen hand gesture trajectory models.

6. A hand gesture trajectory recognition apparatus, comprising:
a model defining unit for pre-defining sixteen hand gesture trajectory models, and classifying the sixteen hand gesture trajectory models into three types of hand gesture trajectory models in accordance with the number of key points included in respective hand gesture trajectory models of the sixteen hand gesture trajectory models;
a type judging unit for judging an input hand gesture trajectory belongs to which type of the three types of hand gesture trajectory models in accordance with the number of key points included in the input hand gesture trajectory; and
a trajectory recognizing unit for recognizing input hand gesture trajectories that belong to different types of hand gesture trajectory models with different methods,
wherein, as to any one of the sixteen hand gesture trajectory models or the input gesture trajectory, its start point and end point are both key points, and for any one current point on the one hand gesture trajectory model or the input hand gesture trajectory, if the current point is located within a same quadrant as a previous key point, the current point is judged as a regular point, or else the current point is judged as a key point.

7. The hand gesture trajectory recognition apparatus of claim 6, characterized in that the type judging unit takes hand gesture trajectory models, the number of key points included in which is less than or equal to “4”, as a first type of hand gesture trajectory models, takes hand gesture trajectory models, the number of key points included in which is larger than 4 and not larger than 10, as a second type of hand gesture trajectory models, and takes hand gesture trajectory models, the number of key points included in which is larger than 10, as a third type of hand gesture trajectory models.

8. The hand gesture trajectory recognition apparatus of claim 7, characterized in that when the input hand gesture trajectory belongs to the first type of hand gesture trajectory models, the trajectory recognizing unit judges the input hand gesture trajectory shall be taken as which one hand gesture trajectory in the first type of hand gesture trajectory models by comparing a code chain of the input hand gesture trajectory and code chains of every hand gesture trajectory models in the first type of hand gesture trajectory models.

9. The hand gesture trajectory recognition apparatus of claim 7, characterized in that when the input hand gesture trajectory belongs to the second or third type of hand gesture trajectory models, the trajectory recognizing unit judges the input hand gesture trajectory shall be taken as which one hand gesture trajectory model in the second or third hand gesture trajectory models by comparing a difference mode in a code chain of the input hand gesture trajectory and difference modes in code chains of the second or third types of hand gesture trajectory models.

10. The hand gesture trajectory recognition apparatus of claim 6, characterized in that the model defining unit uses code chains respectively corresponding to the sixteen hand gesture trajectory model to represent the sixteen hand gesture trajectory models.
